(19) United States
(12) Patent Application Publication
(10) Pub. No.: US 2016/0335040 A1
(43) Pub. Date: Nov. 17, 2016

(54) DISPLAY SYSTEM AND DISPLAY METHOD OF DISPLAY SYSTEM

(71) Applicant: Coretronic Corporation, Hsin-Chu (TW)

(72) Inventor: Fu-Ching Wen, Hsin-Chu (TW)

(21) Appl. No.: 15/151,460

(22) Filed: May 10, 2016

(30) Foreign Application Priority Data
May 15, 2015 (CN) 201510247560.1

(51) Int. Cl. G06F 3/14; G06T 1/20

(52) U.S. Cl. CPC G06F 3/1446; G06T 1/20

(57) ABSTRACT

A display system and a display method of the display system are provided. A master electronic device transmits image parameters to slave electronic devices to enable the slave electronic devices to adjust sizes of video images outputted by the slave electronic devices according to the image parameters. The master electronic device combines the video images outputted by the slave electronic devices and a video image provided by the master electronic device to generate a split image for a display device performing display. Thereby, utilization convenience of the display system is enhanced.

### CROSS-REFERENCE TO RELATED APPLICATION

This application claims the priority benefit of China application serial no. 201510247560.1, filed on May 15, 2015. The entirety of the above-mentioned patent application is hereby incorporated by reference herein and made a part of this specification.

### BACKGROUND OF THE INVENTION

1. Field of the Invention

The invention relates to an electronic device, and in particular, a display system and a display method of the display system.

2. Description of Related Art

Audiovisual streaming refers to transmission of multi-media data such as voice, images, and videos using network packets. Conventionally, the data is simultaneously received and played at a receiving end to thereby achieve the effect of instant play. Currently, there are numerous websites providing streaming services of video clips. Moreover, the video conferencing service also makes use of media streaming technologies.

The current audiovisual streaming technologies include one-to-one and one-to-multiple frameworks. In a traditional one-to-one framework, a display device is limited to being connected to only one single data transmitting end at a time. On the other hand, in a traditional one-to-multiple framework, although the display device simultaneously receives audiovisual data from different data transmitting ends to display a split image, the display device needs to have corresponding supporting hardware so as to achieve this function.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a display system and a display method thereof. Through one-to-one framework without adding hardware components, the display system can achieve/realize the function of split image display performed by a multiple-to-one framework, thereby utilization convenience of the display system is enhanced.

Other purposes and advantages of the invention can be further understood through the technical features disclosed by the invention.

To achieve one of, part of, or all of the aforementioned or other purposes, one embodiment of the invention provides a display system for displaying a split image having a plurality of video windows. The display system includes a master electronic device, a plurality of slave electronic devices, and a display device. The master electronic device outputs image parameters to the slave electronic devices according to sizes of the video windows in the split image corresponding to the slave electronic devices. The slave electronic devices adjust sizes of video images outputted by the slave electronic devices according to the image parameters. The master electronic device adjusts a size of a video image provided by the master electronic device according to a size of the video window in the split image corresponding to the master electronic device. Moreover, the master electronic device receives the video images outputted by the slave electronic devices and combines the video images outputted by the slave electronic devices with the video image provided by the master electronic device to generate the split image. A size of each adjusted video image is identical to the size of each of the video windows respectively corresponding to the video images. The display device receives the split image from the master electronic device for display.

In one embodiment of the invention, the master electronic device provides a virtual router to allocate bandwidth to the slave electronic devices and receive the video images outputted by the slave electronic devices.

In one embodiment of the invention, each of the image parameters includes at least one of an image size parameter and a resolution parameter. According to the image parameters, each of the slave electronic devices adjusts the size of each of the video images outputted by each of the slave electronic devices to be identical to the size of each of the video windows corresponding to the slave electronic devices. According to the image parameters, the master electronic device adjusts the size of the video image provided by the master electronic device to be identical to the size of the video window corresponding to the master electronic device.

In one embodiment of the invention, the video images outputted by the slave electronic devices are screenshots of the slave electronic devices, and the video image provided by the master electronic device is a screenshot of the master electronic device.

In one embodiment of the invention, data transmission between the master electronic device and each slave electronic device and data transmission between the master electronic device and the display device are performed via wireless communication.

In one embodiment of the invention, the display system further includes a receiving device. The receiving device is coupled to the display device for receiving the split image from the master electronic device and forwarding the split image to the display device for display.

A display method of a display system of the invention is used for displaying a split image having a plurality of video windows. The display method of the display system includes the following steps. A master electronic device of the display system outputs image parameters to slave electronic devices of the display system according to sizes of the video windows in the split image corresponding to the slave electronic devices, such that the slave electronic devices adjust sizes of video images outputted by the slave electronic devices according to the image parameters. The master electronic device adjusts a size of a video image provided by the master electronic device according to a size of the video window in the split image corresponding to the master electronic device. The master electronic device receives the video images outputted by the slave electronic devices and combines the video images outputted by the slave electronic devices with the video image provided by the master electronic device to generate the split image. A size of each adjusted video image is identical to the size of each of the video windows respectively corresponding to the video images. A display device of the display system receives the split image from the master electronic device for display.

In one embodiment of the invention, the display method of the display system further includes the following step. A virtual router is provided by the master electronic device to allocate bandwidth of the master electronic device to the slave electronic devices, such that the master electronic device receives the video images outputted by the slave electronic devices.

In one embodiment of the invention, each of the image parameters includes at least one of an image size parameter and a resolution parameter. According to the image parameters, each of the slave electronic devices adjusts the size of each of the video images outputted by each of the slave electronic devices to be identical to the size of each of the video windows corresponding to the slave electronic devices. According to the image parameters, the master electronic device adjusts the size of the video image provided by the master electronic device to be identical to the size of the video window corresponding to the master electronic device.

In one embodiment of the invention, the video images outputted by the slave electronic devices are screenshots of the slave electronic devices, and the video image provided by the master electronic device is a screenshot of the master electronic device.

In one embodiment of the invention, data transmission between the master electronic device and each slave electronic device and data transmission between the master electronic device and the display device are performed via wireless communication.

In light of the above, in the embodiments of the invention, with the master electronic device transmitting the image parameters to the slave electronic devices, the slave electronic devices are enabled to adjust the sizes of the video images outputted by the slave electronic devices according to the image parameters. Moreover, the master electronic device combines the video images outputted by the slave electronic devices with the video image provided by the master electronic device to generate the split image for the display device performing display. Therefore, through one-to-one framework without adding hardware components, the display system may achieve/realize the function of split image display performed by a multiple-to-one framework, thereby utilization convenience of the display system is enhanced.

To provide a further understanding of the aforementioned and other features and advantages of the invention, exemplary embodiments, together with the reference drawings, are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic view of a display system according to one embodiment of the invention.

FIG. 1B is a schematic view of another display system according to one embodiment of the invention.

FIG. 2 is a flow chart of a display method of a display system according to one embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

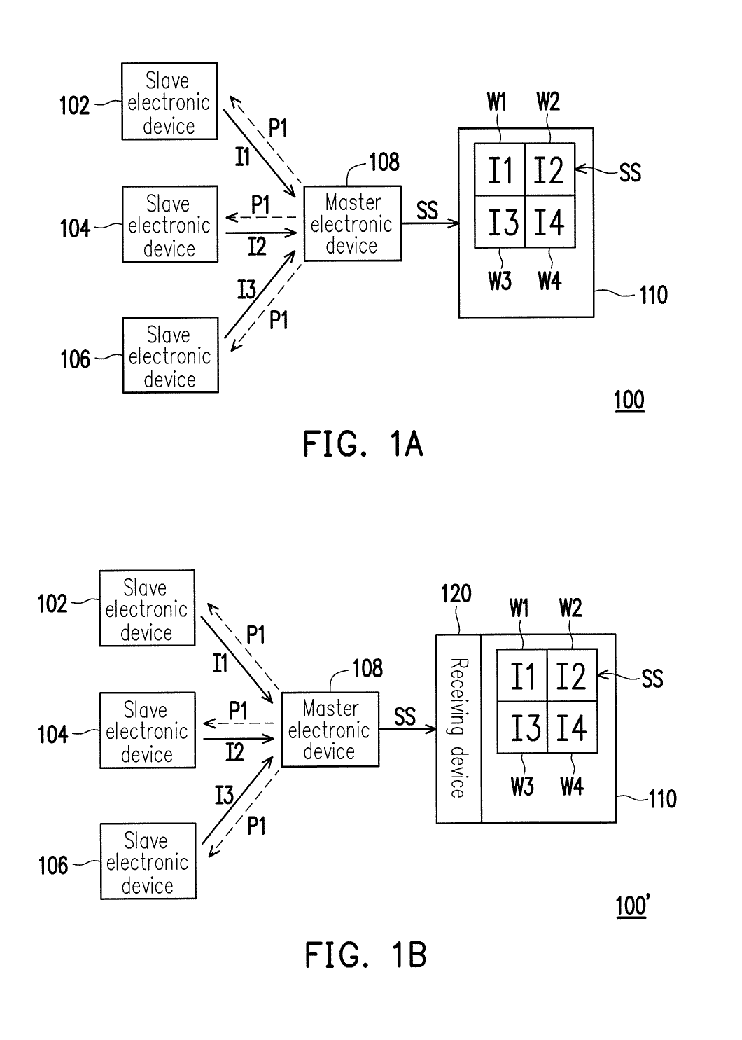

FIG. 1A is a schematic view of a display system according to one embodiment of the invention. Referring to FIG. 1A, a display system 100 includes a plurality of slave electronic devices 102, 104, 106, a master electronic device 108, and a display device 110. For convenience of description, the embodiment describes the three slave electronic devices 102, 104, 106 for illustration. However, the number of the slave electronic devices is not limited thereto. In the embodiment, the slave electronic devices 102, 104, 106 and the master electronic device 108 are mobile phones, tablet computers, notebook computers, laptops, or other devices capable of providing image/video signals, for example. The display device 110 is a liquid crystal screen, a projector, a mobile phone, a tablet computer, a notebook computer, a laptop, or other device capable of displaying images/videos, for example.

In the embodiment, the display device 110 of the display system 100 is used for displaying a split image SS. The split image SS includes a plurality of video windows W1, W2, W3, and W4. In the embodiment, the video windows W1, W2, W3 respectively correspond to the slave electronic devices 102, 104, 106, and the video window W4 corresponds to the master electronic device 108. More specifically, in the embodiment, the video window W1 is a video related to a video image I1 from the slave electronic device 102, the video window W2 is a video related to a video image I2 from the slave electronic device 104, the video window W3 is a video related to a video image I3 from the slave electronic device 106, and the video window W4 is a video related to a video image I4 from the master electronic device 108.

In the embodiment, according to sizes of video windows in the split image SS corresponding to the slave electronic devices 102, 104, 106 (namely, sizes of the video windows W1, W2, W3), the master electronic device 108 may output image parameters P1 to the slave electronic devices 102, 104, 106, such that the slave electronic devices 102, 104, 106 may respectively adjust sizes of the video images I1, I2, I3 according to the image parameters P1. Specifically speaking, according to the sizes of the video windows W1, W2, W3 in the default split image SS, the master electronic device 108 outputs the image parameters P1 to the slave electronic devices 102, 104, 106, and the image parameters P1 may include an image size parameter, a resolution parameter, or other image-related parameters, for example. According to the image parameters including the image size parameter and the resolution parameter, the slave electronic devices 102, 104, 106 respectively adjust video characteristics including image sizes and resolutions of the video images I1, I2, I3 outputted by the slave electronic devices 102, 104, 106, such that the video characteristics including the image sizes and resolutions of the adjusted video images I1, I2, I3 are identical to video characteristics including image sizes and resolutions of the video windows W1, W2, W3 respectively corresponding to the video images I1, I2, I3. More specifically, in the embodiment, the size adjustment made to the images is scaling (scaling up or scaling down), for example. However, the invention is not limited thereto.

In addition, according to the size of the video window in the split image SS corresponding to the master electronic device 108 (namely, the video window W4), the master electronic device 108 may adjust a size of the video image I4 provided by the master electronic device 108. Specifically speaking, in the embodiment, the master electronic device 108 may also adjust an image size/resolution of the video image I4 according to an image size/resolution of the video window W4, such that the image size/resolution of the adjusted video image I4 is identical to an image size/resolution of the video window W4.

Further to the above, after the adjusted video images I1, I2, I3, I4 are obtained, the master electronic device 108 may combine the video images I1, I2, I3, I4 to generate the split image SS and transmit the split image SS including the adjusted video images I1, I2, I3, I4 to the display device 110 for display.

In light of the above, through the master electronic device 108 transmitting the image parameters P1 to the slave electronic devices 102, 104, 106, the slave electronic devices 102, 104, 106 are enabled to adjust the sizes of the video images I1, I2, I3 according to the image parameters P1, therefore the amount of data processed by the master electronic device 108 may be effectively reduced by allowing the master electronic device 108 to be responsible only for adjustment of the video image I4 provided by itself and for combination of the video images I1, I2, I3, I4. Thereby, the embodiment may avoid a situation that playing of audiovisual streaming of the display system 100 is affected due to insufficient data processing capacity of the master electronic device 108. In addition, since the display device 110 may only receive the split image SS integrated/outputted from the master electronic device 108, the framework of the display device 110 and the master electronic device 108 is still a one-to-one framework. Therefore, through one-to-one framework of the embodiment without adding hardware components, the display system 100 may still achieve/realize the function off split image display displayed by the traditional multiple-to-one framework, such that the utilization convenience of the display system 100 is significantly enhanced.

In the embodiment, data transmission between the master electronic device 108 and the slave electronic device 102/104/106 may be performed via wireless communication, and data transmission between the master electronic device 108 and the display device 110 may also be performed via wireless communication, e.g., data transmission via WiFi. However, the invention is not limited thereto. In the embodiment, the master electronic device 108 provides a virtual router to allocate Internet Protocol Address(es) (IP address(es)) to the slave electronic devices 102, 104, 106 to share bandwidth and receive the video images I1, I2, I3 from the slave electronic devices 102, 104, 106. On the other hand, each of the slave electronic devices 102, 104, 106 of the embodiment may have a virtual router of its own to connect to a network to download and/or upload data while being connected to the master electronic device 108. In addition, short-range wireless transmission technologies may be adopted for the wireless transmission of the embodiment to allow a user to transmit data in a meeting room via a local area network.

Furthermore, in some embodiments, the display device 110 may forward/transmit the split image SS via an externally connected transmission device, as illustrated in a schematic view of a display system 100′ of another embodiment of the invention in FIG. 1B. Compared to the display system 100 of FIG. 1A, the display system 100′ of FIG. 1B further includes a receiving device 120. The receiving device 120 is coupled to the display device 110. For example, the receiving device 120 is a dongle, such as a USB dongle, a Bluetooth dongle, or a WiFi dongle. However, the invention is not limited thereto. In the embodiment, the receiving device 120 may only receive the split image SS integrated/coordinated/outputted from the master electronic device 108. In other words, the framework of the receiving device 120 and the master electronic device 108 is a one-to-one framework. Since the bandwidth of the receiving device 120 is entirely used for receiving the split image SS and it is not necessary to allocate the bandwidth to video signal sources of a plurality of video images, the display system 100′ may still achieve/realize the function of split image display displayed by the traditional multiple-to-one framework. In addition, in some other embodiments, the receiving device 120 may be implemented/achieved/realized by being integrated within the display device 110.

In the embodiment, the video images I1, I2, I3, and I4 are screenshots respectively of the slave electronic devices 102, 104, 106 and the master electronic device 108, for example. However, the invention is not limited thereto. In other embodiments, the video images may be images of other video data, e.g., images of video data obtained from the network and images of audiovisual files stored in the slave/master electronic device(s). Moreover, in the embodiment, the video windows W1, W2, W3, and W4 have the same size, for example. However, the invention is not limited thereto. In other embodiments, the video windows W1, W2, W3, and W4 have sizes that are not completely identical. In addition, the image parameters mentioned above are not limited to the image size parameter or/and the resolution parameter. In some embodiments, the image parameters may include more adjustment parameters, such as color tone and brightness.

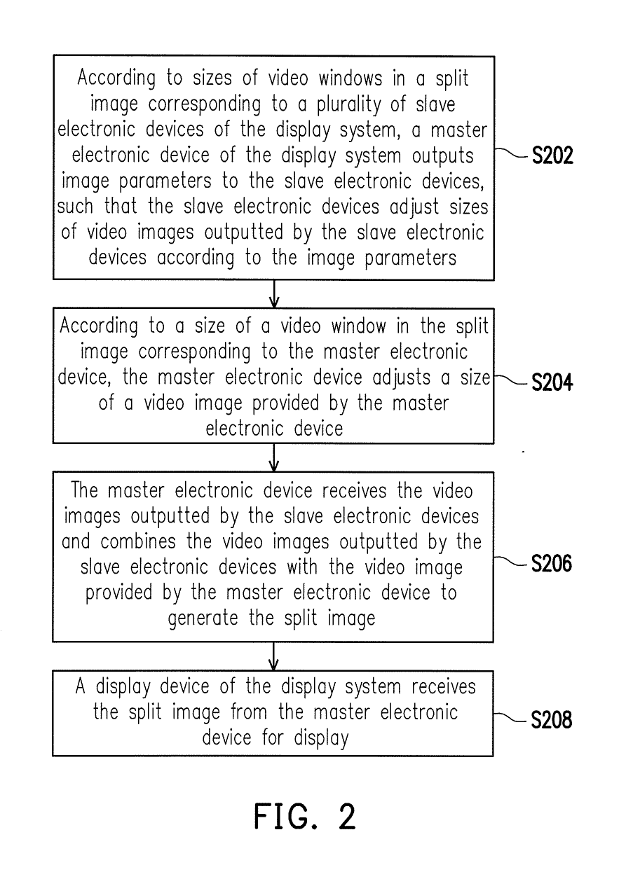

FIG. 2 is a flow chart of a display method of a display system according to one embodiment of the invention. Referring to FIG. 2, according to the above-described embodiment, the display method of the display system includes the following steps. First, according to sizes of video windows in a split image corresponding to a plurality of slave electronic devices of the display system, a master electronic device of the display system outputs image parameters to the slave electronic devices, such that the slave electronic devices adjust sizes of video images outputted by the slave electronic devices according to the image parameters (step S202). In the embodiment, the image parameters include at least one of an image size parameter and a resolution parameter, for example. According to the image parameters including the image size parameter and the resolution parameter, each of the slave electronic devices may adjust video characteristics including image sizes and resolutions of the video images outputted by each of the slave electronic devices to be identical to video characteristics including image sizes and resolutions of the video windows corresponding to each of the slave electronic devices.

Next, according to a size of a video window in the split image corresponding to the master electronic device, the master electronic device adjusts a size of a video image provided by the master electronic device (step S204). In the embodiment, according to the image parameters including the image size parameter and the resolution parameter, the master electronic device may adjust an image size/resolution of the video image provided by the master electronic device to be identical to an image size/resolution of the video window corresponding to the master electronic device. In the embodiment, the video images outputted by the slave electronic devices are screenshots of the slave electronic devices, for example, and the video image provided by the master electronic device is a screenshot of the master electronic device, for example. However, the invention is not limited thereto. In addition, in some embodiments, the master electronic device may provide a virtual router to allocate IP addresses to the slave electronic devices to share bandwidth with the slave electronic devices and further simultaneously receive the video images from the slave electronic devices. On the other hand, each of the slave electronic devices may respectively have a virtual router of its own to connect to a network to download and/or upload data while being connected to the master electronic device.

Next, the master electronic device receives the video images outputted by the slave electronic devices and combines the video images outputted by the slave electronic devices with the video image provided by the master electronic device to generate the split image (step S206), wherein the size of each of the adjusted video images is identical to the size of each of the video windows respectively corresponding to the video images. Afterwards, a display device of the display system receives the split image from the master electronic device for display (step S208). In the embodiment, data transmission between the master electronic device and each slave electronic device is performed via wireless communication, for example, and data transmission between the master electronic device and the display device is also performed via wireless communication, for example. However, the invention is not limited thereto.

In summary of the above, in the embodiments of the invention, through the master electronic device transmitting the image parameters to the slave electronic devices, the slave electronic devices are enabled to adjust the image sizes of the video images outputted by the slave electronic devices according to the image parameters, therefore the amount of data processed by the master electronic device may be effectively reduced by allowing the master electronic device to be responsible only for adjustment of the video image provided by itself and for combination of the video images. Thereby, the embodiments avoid the situation that playing of audiovisual streaming of the display system is affected due to insufficient data processing capacity of the master electronic device. In addition, in the embodiments of the invention, the display device may only receive the split image integrated/coordinated/outputted from the master electronic device. In other words, the display device and the master electronic device are still of a one-to-one framework. Therefore, in the embodiments of the invention, through one-to-one framework of the embodiment without adding hardware components, the display system may still implement/achieve/realize the function of split image display displayed by traditional multiple-to-one framework, thereby utilization convenience of the display system may be significantly enhanced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system, for displaying a split image having a plurality of video windows, the display system comprising:
a master electronic device and a plurality of slave electronic devices,
wherein the master electronic device outputs image parameters to the slave electronic devices according to sizes of the video windows in the split image corresponding to the slave electronic devices,
wherein the slave electronic devices adjust sizes of video images outputted by the slave electronic devices according to the image parameters,
wherein the master electronic device adjusts a size of a video image provided by the master electronic device according to a size of the video window in the split image corresponding to the master electronic device,
wherein the master electronic device receives the video images outputted by the slave electronic devices and combines the video images outputted by the slave electronic devices with the video image provided by the master electronic device to generate the split image, wherein a size of each adjusted video image is identical to the size of each of the video windows respectively corresponding to the video images; and
a display device, for receiving the split image from the master electronic device for display.

2. The display system according to claim 1, wherein the master electronic device provides a virtual router to allocate bandwidth to the slave electronic devices and receive the video images outputted by the slave electronic devices.

3. The display system according to claim 1, wherein each of the image parameters comprises at least one of an image size parameter and a resolution parameter,
wherein each of the slave electronic devices adjusts the size of each of the video images outputted by each of the slave electronic devices to be identical to the size of each of the video windows corresponding to the slave electronic devices according to the image parameters,
wherein the master electronic device adjusts the size of the video image provided by the master electronic device to be identical to the size of the video window corresponding to the master electronic device according to the image parameters.

4. The display system according to claim 1, wherein the video images outputted by the slave electronic devices are screenshots of the slave electronic devices, and the video image provided by the master electronic device is a screenshot of the master electronic device.

5. The display system according to claim 1, wherein data transmission between the master electronic device and each slave electronic device and data transmission between the master electronic device and the display device are performed via wireless communication.

6. The display system according to claim 1, further comprising:
a receiving device, coupled to the display device, for receiving the split image from the master electronic device and forwarding the split image to the display device.

7. A display method of a display system, for displaying a split image having a plurality of video windows, the display method of the display system comprising:
outputting image parameters to a plurality of slave electronic devices of the display system according to sizes of the video windows in the split image corresponding to the slave electronic devices by a master electronic device of the display system, such that the slave electronic devices adjust sizes of video images outputted by the slave electronic devices according to the image parameters;
adjusting a size of a video image provided by the master electronic device according to a size of the video window in the split image corresponding to the master electronic device by the master electronic device;
receiving the video images outputted by the slave electronic devices and combining the video images outputted by the slave electronic devices with the video image provided by the master electronic device to generate the split image by the master electronic device, wherein a size of each adjusted video image is identical to the size of each of the video windows respectively corresponding to the video images; and
receiving the split image from the master electronic device for display by a display device of the display system.

8. The display method of the display system according to claim 7, further comprising:
providing a virtual router by the master electronic device to allocate bandwidth of the master electronic device to the slave electronic devices, such that the master electronic device receives the video images outputted by the slave electronic devices.

9. The display method of the display system according to claim 7, wherein each of the image parameters comprises at least one of an image size parameter and a resolution parameter,
wherein each of the slave electronic devices adjusts the size of each of the video images outputted by each of the slave electronic devices to be identical to the size of each of the video windows corresponding to the slave electronic devices according to the image parameters,
wherein the master electronic device adjusts the size of the video image provided by the master electronic device to be identical to the size of the video window corresponding to the master electronic device according to the image parameters.

10. The display method of the display system according to claim 7, wherein the video images outputted by the slave electronic devices are screenshots of the slave electronic devices, and the video image provided by the master electronic device is a screenshot of the master electronic device.

11. The display method of the display system according to claim 7, wherein data transmission between the master electronic device and each slave electronic device and data transmission between the master electronic device and the display device are performed via wireless communication.
